(19) United States
(12) Patent Application Publication
(10) Pub. No.: US 2015/0006243 A1
(43) Pub. Date: Jan. 1, 2015

(54) DIGITAL INFORMATION GATHERING AND ANALYZING METHOD AND APPARATUS

(71) Applicant: AZAPA R&D Americas, Inc., Torrance, CA (US)

(72) Inventor: Go Yuasa, Rancho Palos Verdes, CA (US)

(21) Appl. No.: 14/310,691

(22) Filed: Jun. 20, 2014

Related U.S. Application Data
(60) Provisional application No. 61/841,264, filed on Jun. 28, 2013.

(51) Int. Cl. G06Q 30/02

(52) U.S. Cl. CPC G06Q 30/0201
USPC 705/7.29

(57) ABSTRACT

A method for providing a preferred selection from menu using a customer profile, historical transaction data and environmental information is described. The method include capturing a facial image of a customer using a camera, extracting features from the facial image using a face recognition algorism running on a CPU, obtaining current environmental information from a website via computer network using a control algorism running on the CPU, storing transaction data associated with the customer in the database using a POS (Point of Sales) system, calculating a probability distribution of the preferred selection based on conditions including the customer profile, the environment information and transaction data stored in the database using the control algorism running on the CPU, and presenting the preferred selection to the customer in descending order from a largest value of probability to a lowest probability of the calculated probability distribution.

This non-provisional application claims priority from U.S. Provisional Patent Application Ser. No. 61/841,264 filed, Jun. 28, 2013, the content of which are incorporated herein by reference in its entirety.

### FIELD OF THE INVENTION

The present invention relates to a digital information gathering and analyzing method and apparatus, more particularly to a digital information gathering and analyzing method and apparatus for retail stores, such as restaurants and super markets.

### BACKGROUND OF THE INVENTION

In marketing research and advertisement, personalization and specificity are two important key factors. In order to obtain useful market information, several technologies have been developed. For example, US Patent Application Publication No.: US 2012/0287281 discloses a consumer interfaces and transaction systems for restaurants to create an individual profile for repeat customers to provide them with a better services when they are recognized on the following visit. Also, the individual profile includes his/or her financial data.

However, when utilizing those gathered data as a tool for proactively sell products to the target customers at a timely manner, other items giving more direct impact on actual sales are needed to be added, analyzed and formed to be a tool for promoting actual sales activities and/or for aiming at timely advertisements.

Even though, internet and computer networks have been rapidly spread in business environment and it becomes easy to get necessary information for the business, so far, there is no useful tool for automatically selecting necessary information and analyzing useful data efficiently for the specific business needs.

### SUMMARY OF THE INVENTION

An object of the present invention is to overcome the drawbacks of current technologies described above and provide a digital information gathering and analyzing method and apparatus by utilizing technologies including task automation technologies, algorithmic data analysis and manipulation technologies, which include real time information gathering and situation updating technologies, environmental data via service APIs and personal and specific data collection technologies via facial recognition. It becomes possible to efficiently obtain necessary market data with a timely manner by gathering a large amount of generalized data (age, gender, time etc.) to create a knowledge bank that is immediately applicable to any individual.

A first embodiment of the present invention is a method for providing a preferred selection from a menu for a customer using customer profile, historical transaction data and environmental information. The method includes the steps of

1) capturing a facial image of a customer visiting a restaurant using a camera;

2) extracting features from the facial image using a face recognition algorism running on a CPU (Central Processing Unit);

3) estimating age and gender of the customer using the extracted features from the facial image to from the customer profile using the face recognition algorism running on the CPU;

4) obtaining environmental information via internet using an algorism running on the CPU (Central Processing Unit);

5) storing the environmental information in a database using the algorism running of the CPU, wherein the environmental information includes weather data, temperature data and humidity data;

6) storing transaction data associated with the customer in the database using a POS (Point of Sales) system;

7) calculating a probability distribution of the preferred selection based on conditions including the customer profile, the environment information and transaction data stored in the database using the algorism running on the CPU, the probability distribution predicting likelihood that the customer belonging a certain customer profile selects the preferred selection from the menu associated with the environmental information and historical transaction data of the customer; and

8) presenting the preferred selection to the customer in descending order from a largest value of probability to a lowest probability of the calculated probability distribution.

According to the embodiment described above, each steps can be automatically processed by the algorisms running on the CPU without involvement of employees. Thus, employees of the restaurant can spend more time for customer services, which can improve the sales efficiency of the restaurant activities.

Another embodiment of the present invention is a method for providing advertisement of a preferred selection from a menu. The method includes the steps of:

1) capturing an facial image of a customer visiting a restaurant using a camera;

2) extracting features from the facial image using a face recognition algorism running on a CPU (Central Processing Unit);.

3) estimating age and gender of the customer using the extracted features from the facial image using the face recognition algorism running on the CPU;

4) classifying the estimated age of the customer into one of age groups provided in the facial recognition algorism using the facial recognition algorism running on the CPU;

5) storing the age group of the customer in a database using the face recognition algorism running on the CPU;

6) obtaining environmental information including weather, temperature and humidity information via internet using an algorism running on a CPU (Central Processing Unit);

7) storing the environmental information in the database using the 1 algorism running of the CPU;

8) storing transaction data associated with the customer in the database using a POS (Point of Sales) system;

9) calculating a rate between male and female of customers in the restaurant;

10) calculating a probability distribution of the preferred selection based on the calculated rate between male and female of customers in the restaurant, the age group, time of a day, date of a week, the environmental information and historical transaction data associated with the customer; and

11) displaying the preferred selection for the customer on a display device in descending order from a highest probability to a lowest probability of the calculated probability distribution.

According to the embodiment described above, advertisements of a preferred selection from menu having the highest probability toward the one having lowest probability can be automatically performed by taking account of customer profiles including the rate of male and female and age groups in the restaurant in a timely manner by the algorisms running on the CPU without involvement of employees. Thus, more sales amounts can be expected in a timely manner and employees of the restaurant can spend more time for customer services, which can improve the sales efficiency of the restaurant activities. Also, the response of the advertisements can be obtained at a timely manner. When the results of the advertisements is not what expected, then the result is fed back to the database so that a next advertisement is automatically modified to increase the effectiveness of the advertisements (a self learning function).

Another embodiment of the present invention is a method for providing advertisements of a product. The method includes the steps of:

1) capturing a facial image of a customer visiting a store by a camera;

2) extracting features from the facial image using a face recognition algorism running on a CPU;

3) estimating an age of the customer using the extracted features of the facial image applying a face recognition algorism running on the CPU;

4) obtaining weather information including weather, temperature and humidity via internet using an algorism running on the CPU (Central Processing Unit);

5) storing the weather information in a database using the algorism running of the CPU;

6) storing transaction data of the product associated with the customer in the database via POS (Point of Sales) system;

7) calculating a probability distribution between the product and time of a day, date of a week, the environmental information, and transaction data using the algorism running on the CPU; and

8) creating the advertisements of the product aiming at potential buyers via SNS (Social Network Service) and/or displays according to the calculated probability distribution of the product using a the algorism running on the CPU.

According to the embodiment described above, advertisements of a preferred selection from the products having the most highest probability can be automatically performed via SNS based on the time of the day, the day of the week, environmental information and transaction data using the algorisms running on the CPU without involvement of employees. Since the advertisement of the product can be automatically performed aiming at a specific target customer based on the stored data, the accuracy and effectiveness of the advertisement can be improved and more sales amounts can be expected in a timely manner.

### BRIEF DESCRIPTION OF THE DRAWING

FIG. 1 illustrates a system configuration of a digital information gathering and analyzing apparatus.

FIG. 2 illustrates three types of data sources used in the digital information gathering and analyzing apparatus illustrated in FIG. 1.

FIG. 3 illustrates a facial recognition system used in the digital information gathering and analyzing apparatus.

FIG. 4 illustrates a basic concept of relationship between data elements pertaining to customers or customer groups, which are modified and updated with new transactions associated with the customers or the customer groups.

FIG. 5 illustrates a system configuration of a digital information gathering and analyzing apparatus of an embodiment of the present invention.

FIG. 6 illustrates a flow chart of a process of the digital information gathering and analyzing apparatus in FIG. 5 when a customer visits the restaurant having thereof.

FIG. 7 illustrates an example of output of the digital information gathering and analyzing apparatus of an embodiment of the present invention which provides a correlation factor or a probability distribution between relevant products which are expected to be sold together at a specific time frame.

FIG. 8 illustrates an example of advertisement using a social network system which displays an advertisement of specific products aiming at potential customers belong to a specific age group and an age group.

FIG. 9 illustrates features or advantages of an embodiment of the present invention being task automation of in gathering data, analyzing data and offering business recommendations and advertisements.

### DETAILED DESCRIPTION OF THE INVENTION

Referring to the drawings, the following describes the details of an embodiment of the present invention pertaining to a digital information gathering and analyzing method and apparatus to be used in retail store industries, such as restaurants and retail stores to improve profit and sales amounts of the stores.

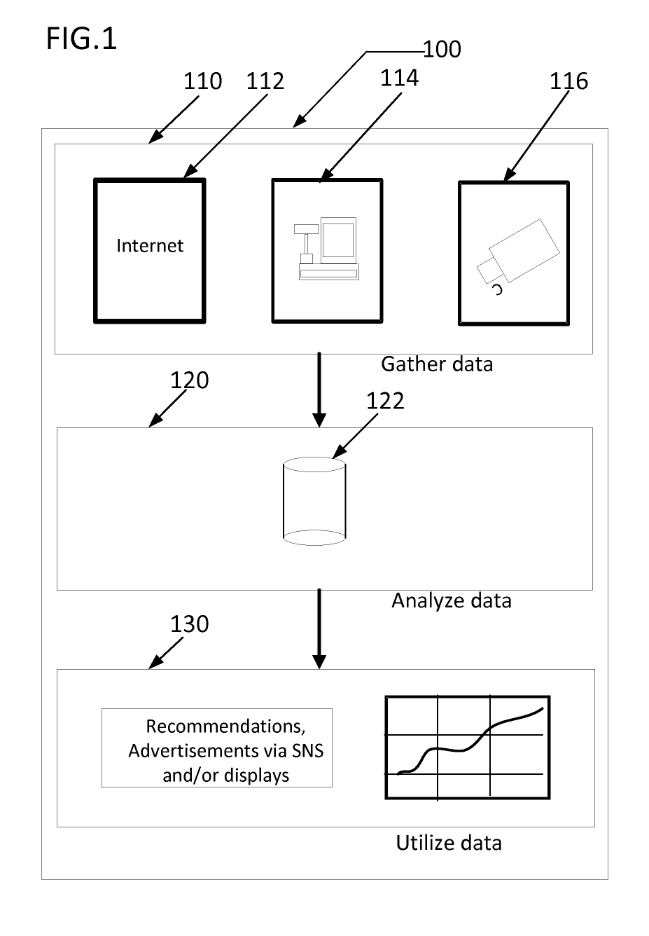

FIG. 1 illustrates a system configuration of the digital information gathering and analyzing apparatus 100. The digital information gathering and analyzing apparatus 100 is configured by three subsystems including a data gathering subsystem 110, a data analyzing subsystem 120 and an application subsystem 130. The data gathering subsystem 110 is designed to obtain environmental information via Internet 112, transaction data from POS (Point of Sales) system 114 and image data of customers captured by a camera 116. The environmental information includes, for example, weather data, event information including sports, conference and seminars, and economic information including stock prices and indexes, which are provided by third party websites via internet 112. The POS (Post Of Sales) system 114 provides transaction data of customers obtained from POS terminals linked to the digital information gathering and analyzing apparatus 100. The camera 116 is arranged to capture image data of customers visiting the store. The camera 116 may be a still camera and/or a video camera.

The data analyzing subsystem 120 includes a CPU (Central Processing Unit, not shown) 122 on which algorisms for executing instructions for obtaining the data from websites via internet 112, POS system 114 and camera 116 and analyzing the data run. The data analyzing subsystem 120 also includes memories (not shown) for storing the algorisms and communication interface (not shown) for communicating with the websites via Internet 112, the POS systems 114 for imputing transaction data and the camera 116 for capturing facial images of customers.

The application subsystem 130 has functions for executing algorisms for utilizing the analyzed data obtained in the analyzing subsystem 120 to create recommendations to the customers and timely advertisements to the specific customers. The algorisms related to the application subsystem 130 are designed to be executed on the CPU 122 in the data analyzing subsystem 120 of the information gathering and analyzing apparatus 100.

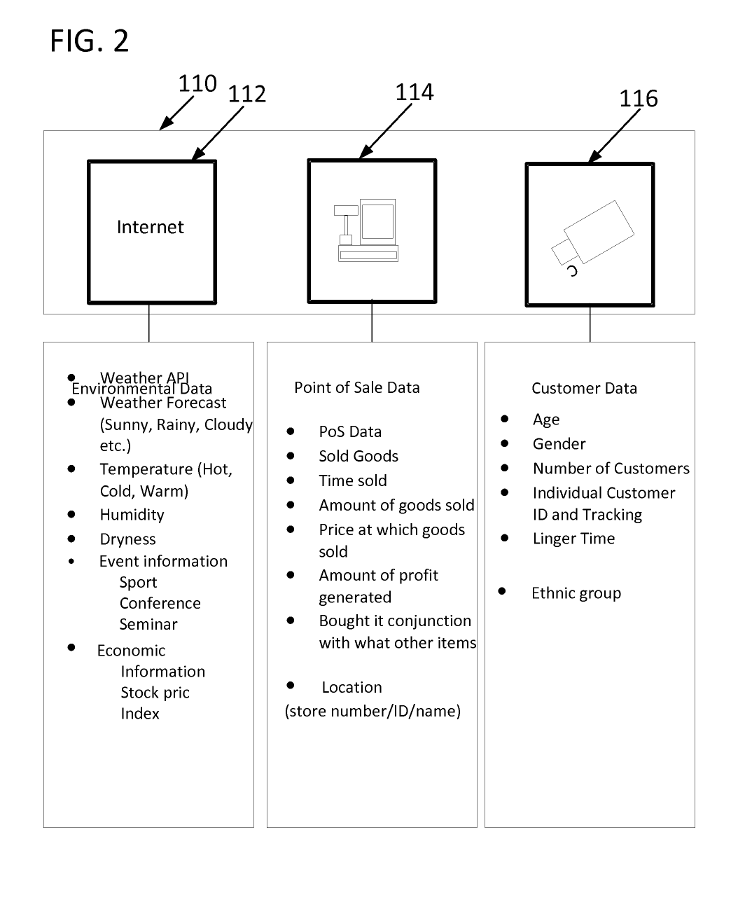

FIG. 2 shows the contents obtained from third party websites via internet 112 in this embodiment. The environmental information includes weather data, which will be provide by, third parties. The third part website provides a web service offering API (Application Programming Interface) which allows users to utilize the service via internet offered in variety of different ways. There is provided current weather and weather forecast (sunny, rainy and cloudy etc), temperature and humidity in the website. The environmental information further includes event information, such as baseball games, football games and/or music festivals held vicinity of the restaurant and traffic information provided by the third party websites where a lot of potential customers can be expected. In the case of big sports event, the results of the games may affect the number of customers coming into the sports bars and restaurants. So the location of the events is not limited to the vicinity of the restaurant. For example, game results of a team related to Los Angeles held in New York affects to the customer numbers expected to visit restaurants and sports bars in Los Angeles. Environmental information also may include economic information including stock prices.

The POS (Point of Sales) system 114 provides transaction data of each customer and a customer group visiting the restaurant. The transaction data includes types of sold goods, time sold, amount of goods sold, price at which the goods were sold, amount of profit generated, a table number where the customer (s) is located, number of customers including the customer group and goods bought in conjunction with other items, for example. These data obtained from POS terminals linked to the POS system 114 are very critical and important in the business because these data are formed into customer database for future use after correlated with other information, for example, environmental information and features extracted from the image data including facial recognition information of customers, which will be described later. In an embodiment of the present invention, these data are also utilized to analyze customer trends and behaviors that will in turn be used to increase customer satisfaction and sales figures.

The camera 116 is arranged to capture facial images of customers visiting the store. The facial images include facial features of the customers from which gender, age and facial expression of customers can be extracted and calculated by the facial recognition algorisms running on the CPU 122. Also, ethical groups into which customers belong are estimated by using the facial features extracted from the facial image obtained by the camera 116. Individual customer ID, tracking information related to the individual in the store, linger time at the store and degree of satisfaction using the facial expression are obtained and calculated utilizing facial recognition technologies. It should be noted that an object of identification of customers in the embodiment of the invention is not to obtain personal information using facial recognition but it is used for classifying customers into features such as age, age groups, and gender which will be used as variables when calculating probability distributions to make recommendations and/or advertisements for aiming at specific customers.

Facial recognition algorism arranged to be executed on the CPU 122, together with the images captured by the camera 116 is designed to automatically estimate age, gender, a satisfaction degree using facial expression of each customer and the number of people in the customer group. The facial recognition algorism is also capable of singling out target individuals like employees and VIPs from captured images. A plurality of cameras may be installed in the store to capture the facial images of customers at a plurality of places in the store. At least a camera 116 is installed at the entrance facing toward the entrance of the store, and at least a camera 116 is installed facing toward the inside of the store so that the facial images of the customers visiting to the store and leaving the store can be obtained. However, there is a case when the camera cannot obtain a facial image of a target customer because the target customer faces different direction from the camera. Accordingly, it is recommended to install a plurality of cameras in a plurality of places in the restaurant to shoot the customer faces to obtain the facial of the customer. Each image obtained by the camera has a time stamp on each image taken by the camera. Then it is possible to calculate the lingering time of the customer by using the time stamp on the first facial image and the time stamp of the last facial image of the same customer. Inventor believes that it is possible to obtain the lingering time of the customers, which may be a slightly different from the true lingering time, but may be considered as lingering time of the customer.

When capturing the facial images of customers at each location where the camera 116 is installed, a time stamp is put on the image data as described above so that the lingering time can be obtained by calculating the difference between the entrance time and the leaving time of the customer by identify the same facial image data, or close enough to each other of the customers obtained by these cameras 116. Further, emotional response of the customer (s), such as, delighted expression, depressed expression, etc can be obtained, analyzed and stored in customer database in the memory. These data can be used to obtain the satisfaction degrees of customers.

Satisfaction degrees of the customer (s) can be estimated by analyzing the captured facial images using the face recognition algorism running on the CPU 122. Since facial recognition algorism works with still images and/or with each frame of video signals of a video camera, the cameras installed in the store may be still cameras and/or video cameras. Further an ethnic group of the customer is identified by analyzing the feature extracted from the facial images taken by the camera.

The individual ID assigned to each customer used in this embodiment is an anonymous name, which is given to each person or each group of the image data obtained by the camera 116 using the facial recognition algorism running on the CPU 122. The age group, gender and/or facial expression are automatically read from the image data using the facial recognition algorism running on the CPU 122. Then these data are stored together with the individual ID in the memory (not shown) of the data analyzing subsystem 120 together with time data when the image is taken from the camera 116.

The environmental information provided by the third party website, the transaction data provided from the POS system 114 and image data of the customer or the customer group provided by the camera 116 are transmitted to the data analyzing subsystem 120. Then algorism arranged running on the CPU 122 analyzes these data to obtain numerical correlation factors between the environmental information, the transaction data and the image data of the customer or customer group.

In other words, the algorism running on the CPU 122 calculates a probability distribution of an event, for example, a selection from a menu in the restaurant under certain conditions including customer profile (an age, and age group and gender, for example), the environment information and transaction data stored in the database in the memory (not shown) in the data analyzing subsystem 120. The probability distribution predicts likelihood that the customer belonging to a certain customer profile selects a preferred selection from the menu associated with the environmental information and historical transaction data of the customer.

In order to correlate the facial recognition data obtained by the camera 116 with the transaction data provided by the POS system 114, the camera 116 may be installed to near the table having a table number to capture the customer sitting in the table of the restaurant, for example. The table number is given to each table of the restaurant so that the table number can be recorded on a merchandized document when an employee takes order from the customer (s), which is used in the transaction of the POS system, for example. Then the facial recognition data to which ID (an identification number) is given can be correlated with the POS data via the table number of the table where the customer (s) has been located.

Further, lingering time of the customer can be obtained associated with the customer by checking the time stamps on the facial images taken when the customer enters the restaurant and leaves the restaurant. Also, it is possible to calculate the lingering time of the customer by using the time stamp on the first facial image and the time stamp of the last facial image of the same customer as described above.

In another embodiment, the camera 116 is installed in the POS system so that the POS data and the facial recognition data to which ID is given can be correlated with transaction data provided by the POS system 114. Since the environmental information is obtained by being triggered by the facial images took by the camera 116 when the customer enters the restaurant, the environmental information, the facial recognition data being used to form profile of the customer (s) to which ID is given, and the transaction data can be automatically correlated with each other.

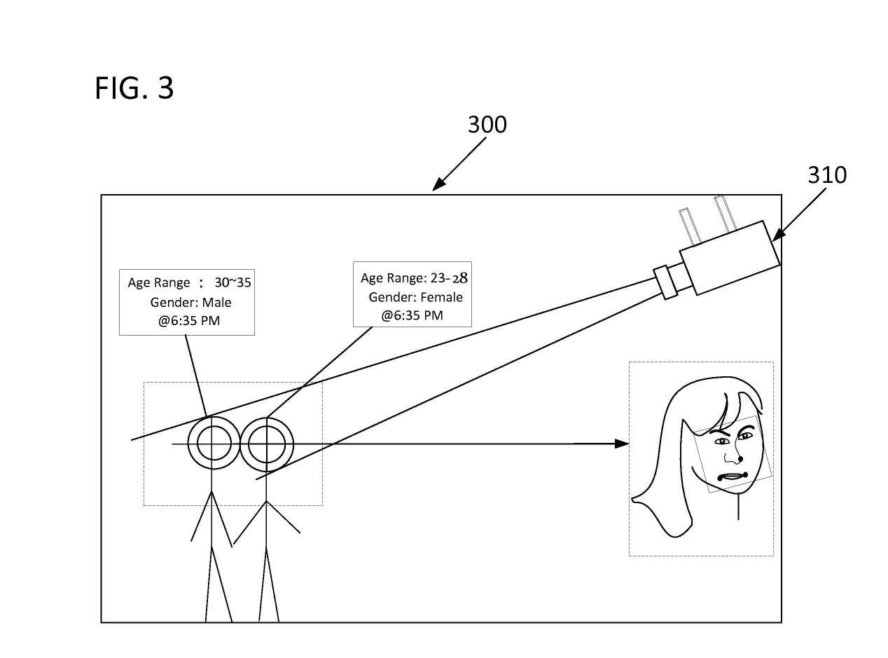

FIG. 3 illustrates a facial recognition system 300 used in the digital information gathering and analyzing apparatus 100. In this example, a camera 310 captures an image including two people. The facial recognition algorism for analyzing features of captured facial image of each person is arranged to run on the CPU 112 in the data analyzing subsystem 120 (referring to FIG. 1) to estimate the age or the age group, the gender and the satisfaction degree using facial expression of the captured images by the camera 310 together with the time stamp on the facial image when the image is taken, In this example, the camera 310 is taking two people, but not limited to two people, one or a plurality people more than two will be acceptable.

According to this embodiment, the output of the facial recognition system 300 shows the data including two people, one belonging to age group 30-35, gender: Male, and another belonging to age group: 23-28, Gender: Female, the image being captured at time of 6:35 PM by utilizing specific data associated with each component in the face of customers.

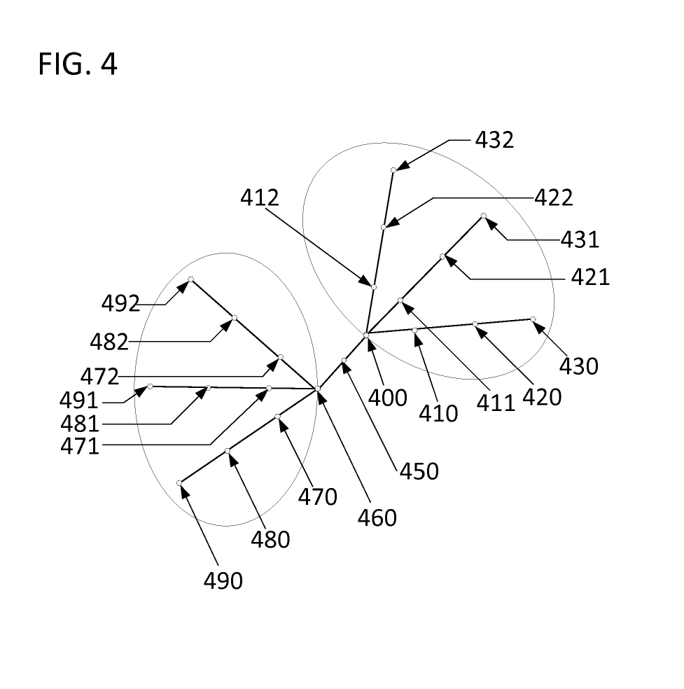

FIG. 4 illustrates a basic concept of the data elements of a customer or a customer group of the present invention. The digital information gathering and analyzing apparatus 100 is arranged to perform self-learning algorithms for accumulating newly developed data, for analyzing and modifying the accumulated data for future use. The digital information gathering and analyzing apparatus 100 of an embodiment of the present invention requires deep and careful analysis of a wide range of data, as opposed to simply matching gathered individualized data, which leads to fundamentally different development procedures comparing with current technologies.

Large amounts of data need to be properly analyzed to be used to form specific market information required for a specific type of store needs. These algorithms take in large amounts of data to determine the relationship (correlations) between all the data. FIG. 4 shows two customer groups 400 and 460. Both customer groups 400 and 460 include three customers 410˜412 and 470˜472 respectively. Both groups enter the restaurant at the same time data 450. The camera 310 (referring to FIG. 3) captures facial image of all customers, 410˜412 and 470˜472. The data elements 420˜422 and 480˜482 represent age groups of each customer. The data elements 430˜432 and 490˜492 represent selected menu data, each customer has selected. When other transaction is performed, related data is added to the current data of the customer and/or customer group to update the data base. In this case two customer groups 400 and 460 are correlated with each other via time data 450. However, from these data, the correlation values between, for example, the menu selected and age group to which each customer belongs to can be calculated, which can be utilized as marketing information later. The correlation value is not limited to this. For example, correlation value between selected menu, time data, weather data, temperature data and humidity data may be calculated using the algorism.

Statistically relevant information and connections produced by advanced algorithms are beyond what humans are able to visualize. The digital information gathering and analyzing apparatus 100 takes in and integrates new information to keep up to date with changing trends and new sources of information as described above.

Next, self-learning algorisms associated with the current invention will be described. The self-learning algorism of database is largely depends on what data is added to the database as “feedback” sources. Following is an example of a self-learning algorism associated with the current invention. It is assumed that a customer or a group of customers stopped by at a restaurant utilizing the digital information gathering and analyzing apparatus 100 into which the self learning algorism is installed. The camera 116 installed at the entrance of the restaurant captures the facial image of the customer (s). Also, weather data 112 including time data, day of the week, temperature and humidity are obtained from a website linked to the digital information gathering and analyzing apparatus 100 via computer network or internet. Then, the digital information gathering and analyzing apparatus 100 compares the current customer profile containing current environmental information including weather information with the historical data which has been stored in the customer database in the digital information gathering and analyzing apparatus 100, which also includes transaction data associated with the customer profiles.

When the current data matches or closes to the ones of the historical data, the digital information gathering and analyzing apparatus 100 pickups the menus, which were sold well to the customers(s) who is categorized into the same profile group, a same age group and/or a same gender or any combination thereof in a past. Then, the sales person recommends or advertizes the menu selected by the digital information gathering and analyzing apparatus to the customers.

The results of the sales is inputted to the digital information gathering and analyzing apparatus 100 from the POS system 114 in a real time or later time as feedback information. Then, the digital information gathering and analyzing apparatus 100 is able to have more information which increases the stored data which refines the stored customer profile whether or not new menu or the same menu is selected form the customer(s). This self-leaning algorism is installed in the algorisms used in an embodiment of the present invention.

Followings are some examples of functions of an embodiment of the present invention.

### Example 1

Following is an example of self learning algorism used when offering additional menu automatically selected by the digital information gathering and analyzing apparatus 100 under a specific conditions described below:

Current time and day of the week: 17:00˜17:30, Thursday

Gender distribution of customers currently staying in the restaurant: Men: 70%, Female: 30%

Current weather/Temperature/Humidity: Fine/70˜75 F/35-40%

Historical data stored in the digital information gathering and analyzing apparatus 100 shows that French-flies is sold at the probability value of 73% and beer can be sold at the probability value of 61% under the current weather and customer data listed above.

Then, the digital information gathering and analyzing apparatus 100 notifies the waiter/waitress of the restaurant that “French-flies” and “beer” should be recommend to the customers or displays advertisement of “French-flies” and “beer” on display device held by the waiter/waitress of the restaurant and/or a digital signage (a display device) in the restaurant. When “French-flies” or “beer” is sold, the sales amount can be increased. If it is unsuccessful, this data is reflected on the data of POS and updated the historical data. In this example, the digital signage is installed in the restaurant. However, it may be arranged outside of the restaurant or outside and inside of the restaurant.

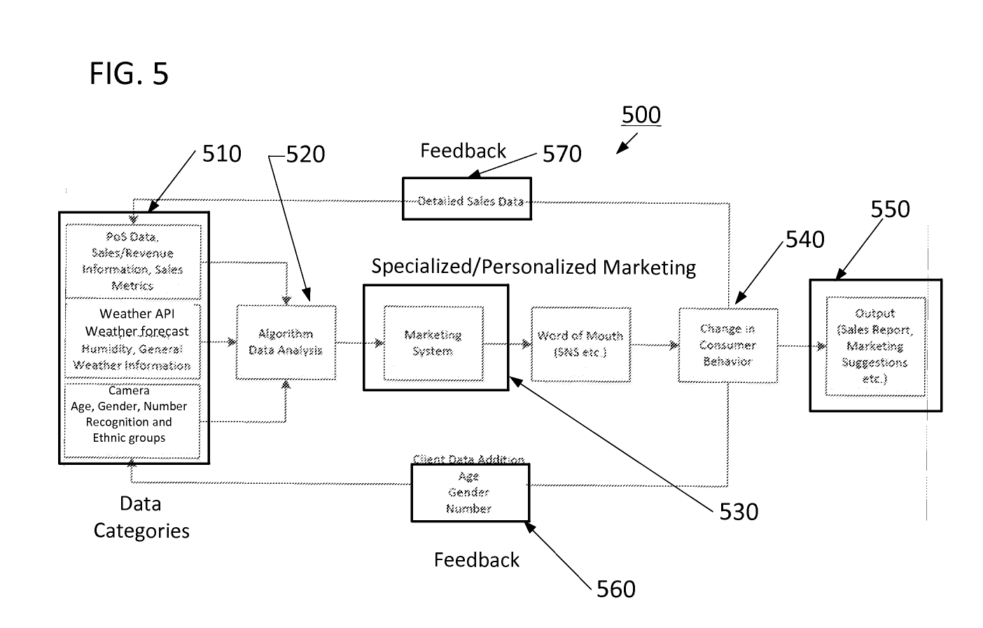

FIG. 5 illustrates a system configuration of a digital information gathering and analyzing apparatus 500 in an embodiment of the present invention. The data gathering subsystem 510 includes POS data obtained by a POS system, environmental information including weather data obtained by a third party website and face-recognition data captured by a camera being transmitted to the data analyzing subsystem 520. The POS data, weather data and face-recognition data are utilized as basic data in the digital information gathering and analyzing apparatus 500. An algorithm/data analyzing subsystem 520 contains 1) an algorism for obtaining environmental information from a website via computer network or internet, POS data and face-recognition data, and for controlling data from POS system together with the environmental information from the website and facial recognition data from the camera to calculate the correlation factors of each event to obtain the probability distribution between events occurring associated with the customer including transaction data and environmental data, 2) facial recognition algorism for extracting features of the facial image data captured by the camera and for calculating estimated an age or an age group to which the customer falls to form customer profile.

Under the algorism, there is calculated the probability of each menu to be sold under a specific condition, such as environmental conditions including weather of the day, temperature and humidity, the age group, gender of the customer, time of the day and the day of the week when the specific menu is sold. In other words, the correlation value of each menu is calculated associated with weather information and customer profile including gender, age group of the customer associated with the POS data.

The algorithm/data analyzing subsystem 520 determines whether or not the profiles of the current customer(s) matches to or closes to the one in the historical data by comparing newly captured data with the historical data. Further, the historical data including the facial recognition data, weather data and POS data are analyzed to calculate the probability of each possible menu to be sold under the current environmental conditions, such as, weather data, temperature, humidity, age group of the customer, time and day of the week and transaction data. Then, the recommended menus having the higher probability will be provided. Based on the determinations of the data analyzing subsystem 520, the marketing system 530 outputs the recommendations to the customer based on the historical data, which is presented to the customers directly, digital signage in the store and/or via a word of mouth (for example SNS (Social Network Service etc.) This task is automatically performed by the digital information gathering and analyzing apparatus 500 so that restaurant stuffs can spend their time to their customers.

The results of the sales (transaction data) and/or the advertisement of recommended menu are added to the historical data via feedback loop 560 or 570 to update the historical data via POS systems as shown in FIG. 5.

When a customer or a group of customers stops by at a restaurant, the digital information gathering and analyzing apparatus 500 compares the customer profile visiting the restaurant and current environmental information obtained by the digital information gathering and analyzing apparatus 500 with the stored data including customer profiles associated with transaction data provided by the POS system and environmental information at the algorism data analyzing subsystem 520 illustrated in FIG. 5. Then, when the current data does not match or is not close to the ones of the stored data, the digital information gathering and analyzing apparatus 500 add those data including transaction data as new data to the database in the digital information gathering and analyzing apparatus 500.

The results of the sales and/or advertisements of the goods is input to the digital information gathering and analyzing apparatus 500 from the POS system in a real time or later time as feedback information through the feedback loop 560 or 570 as illustrated in FIG. 5.

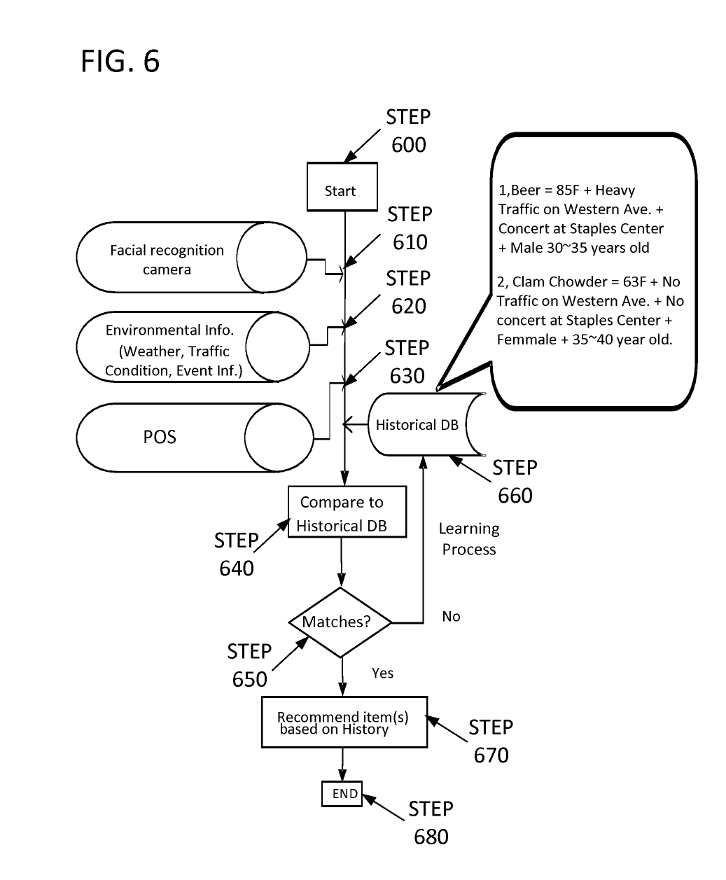

FIG. 6 illustrates a flow chart of the process of the digital information gathering and analyzing apparatus 500 when customers visit the restaurant having thereof. When a customer visits the restaurant having the apparatus, the facial image data is taken by the camera installed at the entrance of the restaurant, (STEP 610). Then, the facial image data is analyzed to extract facial features of the customer to obtain estimated an age and/or an age group, gender and facial expressions of the customer. Environmental information includes weather information, traffic information associated with the location of the restaurant, for example, cross streets and related highway/free way is obtained from related websites via internet, (STEP 620).

The analyzed facial recognition data of the customer is compared with the historical customer data stored in the digital information gathering and analyzing apparatus 500. (STEP 640).

When the digital information gathering and analyzing apparatus 500 recognizes that the current customer profile is the same or close enough to customer profile in the historical data, the waiter or waitress obtains the information via a handy terminal thereof and recommends the menu sold to the customer or the customer having the similar type of profile in a past, (STEP 670). When the digital information gathering and analyzing apparatus 500 determines that the customer is new to the restaurant or that there is no customer having the similar type of profile, the historical transaction data having higher probability is automatically pickup based on the higher probability distribution of the combination of the gender, the age group, the weather condition, for example, to make recommendations to the customer.

When the digital information gathering and analyzing apparatus 500 does not find the same profile or the profile being close to the current customer, the new data including the facial recognition data, the POS data and environmental information including current weather information together with other environmental information is added to the historical database in the digital information gathering and analyzing apparatus 500, (STEP 660).

### Example 2

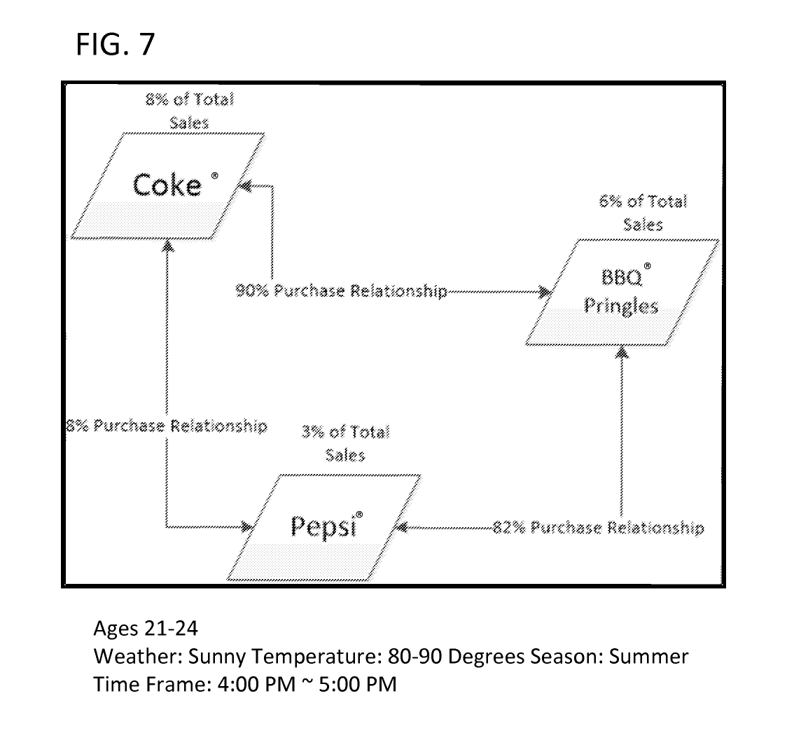

FIG. 7 illustrates anther embodiment of the present invention. According to an embodiment of the present invention, the digital information gathering and analyzing apparatus 500 is arranged to provide a potential relationship between relevant products. This example outlines a potential relationship between Coke®, Pepsi® and BBQ Pringles® at a market place under the weather condition: a sunny summer day, a time frame: 4:00 PM˜5:00 PM, temperature: 80-90 Degrees and target age range being ages 21-24.

According to this example, on a sunny and hot day, Coke® sells fairly well, more than Pepsi®. BBQ Pringles® are often bought in conjunction with Coke® as well. Thus, advertisements that push Coke® and BBQ Pringles® towards young adults is planed during this time frame.

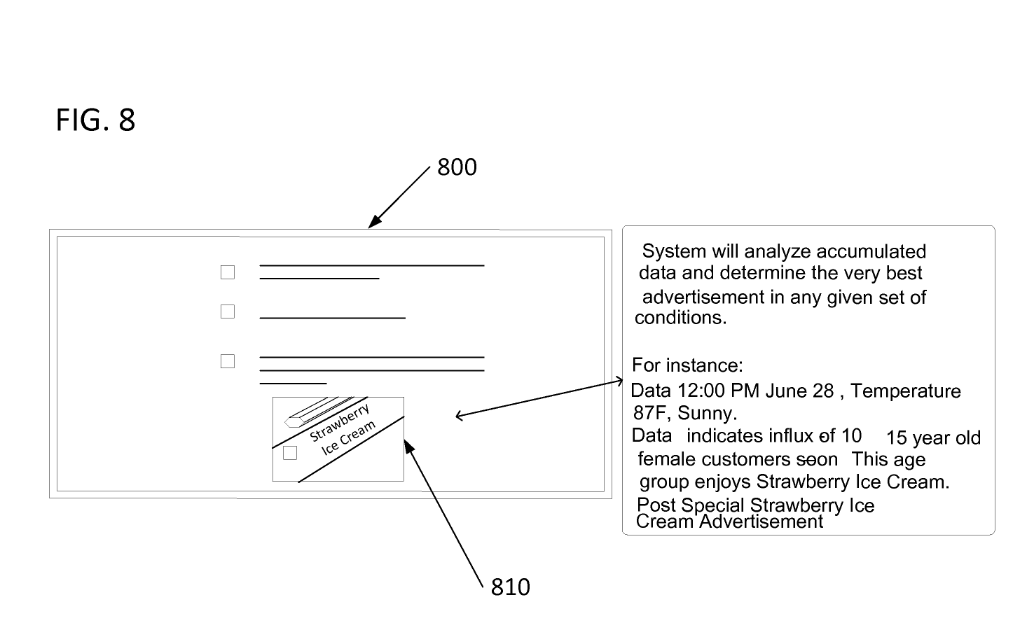

FIG. 8 illustrates an example of output of the digital information gathering and analyzing apparatus 500 in an embodiment of the present invention using SNS (Social Network Service) associated the digital information gathering and analyzing apparatus.

Word-of-Mouth marketing (WOM marketing) being also called word of mouth advertising is an unpaid form of promotion in which satisfied customers tell other people how much they like a business, product, service, or event. SNS (Social Networking Service) is a web based service that makes it easy to set up, operate, and send notifications from cloud.

SNS has created a brand new huge opportunity for utilizing the power of WOM marketing and advertising tactics. SNS allows WOM advertising to include entire social circles ranging from family, to co-workers, and even strangers.

An embodiment of the digital information gathering and analyzing apparatus of the present invention will be shown below.

### Example 3

FIG. 8 illustrates an example of advertisement using SNS (social network system) which displays an advertisement of specific products aiming at potential customers belong to a specific age group.

Current time, date and weather condition: 12:00 PM June 28^{th}, Temperature 87 F, Sunny.

The digital information gathering and analyzing apparatus 500 of the present invention indicates the influx of 10-15 year old female customers soon. —This age group enjoys Strawberry Ice Cream.

Then, the screen of SNS posts “Special Strawberry Ice Cream Advertisement” thereon and/or upload this advertisement on SNS as shown in FIG. 8. In this example, current weather condition is used as described above. In another example, contents of the menu may be changed according to the result of comparison between weather forecast and stored historical data in terms of menu of the restaurant. For, example, when rainfall is forecasted in several hours, the contents of menu of the restaurant can be changed according to the weather forecast based on the historical data.

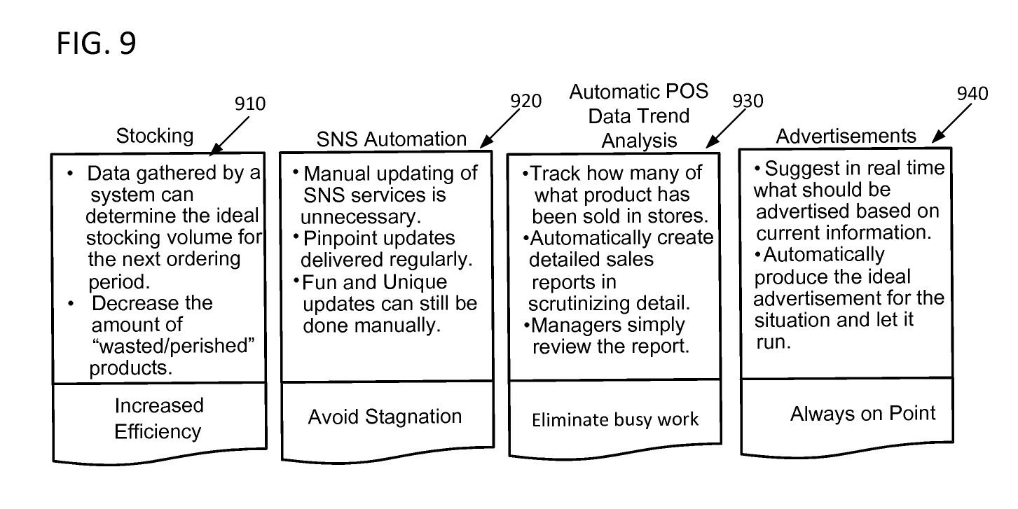

FIG. 9 illustrates a chart of advantages associated with an embodiment of the current invention. The advantages of an embodiment of the present invention includes 1) decreasing stocking volume 910, 2) SNS automation 920, 3) automatic POS data trend analysis 930 and 4) real time advertisements 940. The stocking material volume can be optimized by utilizing the combination of customer profile, weather forecast data and POS data in addition to the basic business planning factors so that the stocking volume can be optimized. SNS service can be performed aiming at a pin point target based on the updated business and environmental conditions automatically without putting special work of employees. By utilizing the POS data, environmental data and customer profile, the detailed sales report can be automatically created. Based on the current updated weather information and historical sales data, advertisements aiming at specific target can be automatically performed in a timely manner.

The forgoing discussion discloses and describes merely exemplary embodiments of the present invention. One skilled in the art will readily recognize from such discussion, and from the accompanying drawings and claims, that various changes, modifications and variations can be made therein without departing from sprit and scope of the invention as defined in the following claims. In these embodiments, an embodiment associated with restaurant has been mainly described. However, an embodiment of the present invention can also be utilized in supermarkets, retailed stores, department stores, hotels, amusement parks, shopping malls and food coats can also be applicable.

What is claimed is:

1. A method for providing a preferred selection from a menu for a customer using a customer profile, historical transaction data and environmental information, the method comprising the steps of:
capturing a facial image of a customer visiting a restaurant using a camera;
extracting features from the facial image using a face recognition algorism running on a CPU (Central Processing Unit);
estimating age and gender of the customer using the extracted features from the facial image to form a customer profile using the face recognition algorism running on the CPU;
obtaining environmental information via internet using an algorism running on the CPU (Central Processing Unit);
storing the environmental information in a database using the algorism running of the CPU, wherein the environmental information includes weather data, temperature data and humidity data;
storing transaction data associated with the customer in the database using a POS (Point of Sales) system;
calculating a probability distribution of the preferred selection based on conditions including the customer profile, the environment information and transaction data stored in the database using the algorism running on the CPU; and
presenting the preferred selection to the customer in descending order from a largest value of probability to a lowest probability of the calculated probability distribution.

2. The method for providing a preferred selection from a menu of claim 1, further comprising the steps of:
classifying the estimated age of the customer into one of age groups using the facial recognition algorism running on the CPU; and
storing the age group of the customer in the database using the face recognition algorism running on the CPU;

3. The method for providing a preferred selection from a menu of claim 1,
wherein the environmental information further includes event information and traffic information.

4. The method for providing a preferred selection from a menu of claim 1, further comprising:
obtaining an emotional response of the customer by calculating emotional data using the extracted features of the facial image using the face recognition algorism running on the CPU;

5. A method for providing advertisement of a preferred selection selected from a menu, the method comprising the steps of:
capturing an facial image of a customer visiting a restaurant using a camera;
extracting features from the facial image using a face recognition algorism running on a CPU (Central Processing Unit);
estimating age and gender of the customer using the extracted features from the facial image using the face recognition algorism running on the CPU;
classifying the estimated age of the customer into one of age groups provided in the facial recognition algorism using the facial recognition algorism running on the CPU;
storing the age group of the customer in a database using the face recognition algorism running on the CPU;
obtaining environmental information including weather, temperature and humidity information via internet using an algorism running on the CPU (Central Processing Unit);
storing the environmental information in the database using the algorism running of the CPU;
storing transaction data associated with the customer in the database using a POS (Point of Sales) system;
calculating a rate between male and female of customers in the restaurant using the algorism running of the CPU;
calculating a probability distribution of the preferred selection based on the calculated rate between male and female of customers in the restaurant, the age group, time of a day, date of a week, the environmental information and transaction data associated with the customer using the algorism running of the CPU; and
displaying the preferred selection for the customer on a display device in descending order from a highest probability to a lowest probability of the calculated probability distribution using the algorism running of the CPU.

6. The method for providing advertisement of preferred selection of claim 5,
wherein the environmental information further includes event information and traffic information, and
wherein the display device is located inside or outside or inside and outside of the restaurant.

7. A method for providing advertisements of a product comprising the steps of:
capturing a facial image of a customer visiting a store by a camera;
extracting features from the facial image using a face recognition algorism running on the CPU (Central Processing Unit);
estimating an age of the customer using the extracted features of the facial image by applying the face recognition algorism running on the CPU;
obtaining weather information including weather, temperatures and humidity via internet using an algorism running on the CPU;
storing the weather information in a database using the algorism running of the CPU;
storing transaction data of the product associated with the customer in the database via POS (Point of Sales) system;
calculating a probability distribution between the product and time of a day, date of a week, the environmental information, and the transaction data using algorism running on the CPU; and
creating the advertisements of the product aiming at potential buyers via SNS (Social Network Service) and/or displays according to the calculated probability distribution of the product using the algorism running on the CPU.

8. The method for providing advertisements of a product of claim 7, further comprising the steps of:
classifying the estimated age of the customer into one of age groups using the facial recognition algorism running on the CPU; and
storing the age groups of the customer in a database using the face recognition algorism running of the CPU,
wherein the advertisements are presented aiming at one of the estimated age groups.

9. The method for providing advertisements of a product of claim 7, further comprising the steps of:
assigning an ID number (identification number) to the customer using the face recognition algorism running on the CPU; and
correlating the transaction data of the product with the customer buying the product using the ID given to the customer using the algorism running on the CPU,
wherein the created advertisements of the product is presented on a screen of the SNS in descending order of from a highest probability to a lowest probability of the calculated probability distribution.

10. The method for providing advertisements of a product of claim 7,
wherein the environmental information further includes event information and traffic information.
